(19) United States
(12) Patent Application Publication
(10) Pub. No.: US 2005/0182507 A1
(43) Pub. Date: Aug. 18, 2005

(54) MSEC/SECS protocol converter and conversion method

(76) Inventors: Hsuan-Hsuan Wu, Tai-Chung City (TW); Wen-Ta Wu, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,017

(22) Filed: Jun. 13, 2004

(30) Foreign Application Priority Data
Feb. 12, 2004 (TW) 093103395

(51) Int. Cl. G06F 19/00

(52) U.S. Cl. 700/121; 700/9

(57) ABSTRACT

The present invention provides a Mitsubishi SEMI Equipment Communication (MSEC)/SEMI Equipment Communication Standard (SECS) protocol converter and conversion method thereof. The MSEC/SECS protocol converter and conversion method utilize an MSEC transceiver to transmit and receive MSEC signals, an SECS transceiver to transmit and receive SECS signals, an MSEC/SECS module to transform MSEC signals into SECS signals, an SECS/MSEC module to transform SECS signals into MSEC signals, and a control character transmission module to transmit control characters. With the MSEC/SECS protocol converter and conversion method, the computer host only needs the SECS interface to communicate the semiconductor apparatus with different protocols, which reduces the complexity and processing requirements of the computer host.

### BACKGROUND OF INVENTION

1. Field of the Invention

The present invention relates to a converter and a conversion method of semiconductor apparatus protocols, and more particularly, to a converter and a conversion method for converting signals between the MSEC protocol and the SECS protocol.

2. Description of the Prior Art

For a more efficient semiconductor process, semiconductor manufacturing factories use some protocols to control and manage semiconductor apparatus. These protocols include SEMI Equipment Communication Standard (SECS) protocol specified by the Semiconductor Equipment and Material Institution (SEMI) and Mitsubishi SEMI Equipment Communication (MSEC) protocol specified by the Mitsubishi company. A computer host needs different protocol interfaces to communicate the semiconductor apparatus having different protocols.

Please refer to FIG. 1. FIG. 1 is a diagram of a computer host 10 and semiconductor apparatus according the prior art. The computer host 10 connects to a plurality of SECS apparatus 22 and a plurality of MSEC apparatus 24. The SECS apparatus 22 are the semiconductor apparatus that communicate using SECS protocol, and the MSEC apparatus 24 are the semiconductor apparatus that communicate using MSEC protocol. The SECS apparatus 22 and the MSEC apparatus 24 are both used to perform the specified semiconductor processes. The computer host 10 comprises an SECS interface 12 which connects to the SECS apparatus 22, an MSEC interface 14 which connects to the MSEC apparatus 24, and an application layer 16. The SECS interface 12 and the SECS apparatus 22 transmit and receive SECS signals 32 using RS-232 ports, and the MSEC interface 14 and the MSEC apparatus 24 transmit and receive MSEC signals 34 using RS-232 ports. The application layer 16 processes data transmitted and received by the SECS interface 12 and the MSEC interface 14.

Because the SECS apparatus 22 and the MSEC apparatus 24 use different protocols, the computer host 10 must use different protocol interfaces to control the connected semiconductor apparatus. Because the computer host 10 can not use the unique protocol to control and manage semiconductor apparatus and the number of the SECS apparatus 22 and the MSEC apparatus 24 is rapidly increasing, integrating the SECS apparatus 22 and the MSEC apparatus 24 is a complicated process.

### SUMMARY OF INVENTION

It is therefore an objective of the claimed invention to provide a conversion method for semiconductor apparatus to convert between the MSEC and SECS protocols.

It is another objective to provide an MSEC/SECS protocol converter applied to a semiconductor manufacture to solve the above-mentioned problem.

According to the claimed invention, a conversion method of semiconductor deice protocol comprises inputting a first signal which is one of an MSEC signal or an SECS signal, judging if the first signal is a control character, outputting the first signal if the first signal is the control character, receiving the first signal, checking the checksum of the received first signal, transforming the first signal into a transformed first signal being an MSEC signal or an SECS signal, computing and updating the length and the checksum of the transformed first signal, and outputting the transformed first signal.

According to the claimed invention, an MSEC/SECS protocol converter comprises a first transceiver, a second transceiver, an MSEC/SECS module, an SECS/MSEC module, and a control character transmission module. The first transceiver is used to transmit and receive MSEC signals, and the second transceiver is used to transmit and receive SECS signals. The MSEC/SECS module transforms MSEC signals into SECS signals, and the SECS/MSEC module transforms SECS signals into MSEC signals. When one of the first or second transceivers receives a control character, the control character transmission module directly transmits the received control character to the other transceiver.

The present invention utilizes the MSEC/SECS protocol converter and the conversion method of semiconductor apparatus protocol to connect the semiconductor apparatus and the computer host to transmit the signals with different protocols. Thus, the computer host only needs the unique interface to transmit and receive signals, which reduces the complexity and processing requirements of the computer host.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a computer host and semiconductor apparatus according the prior art.

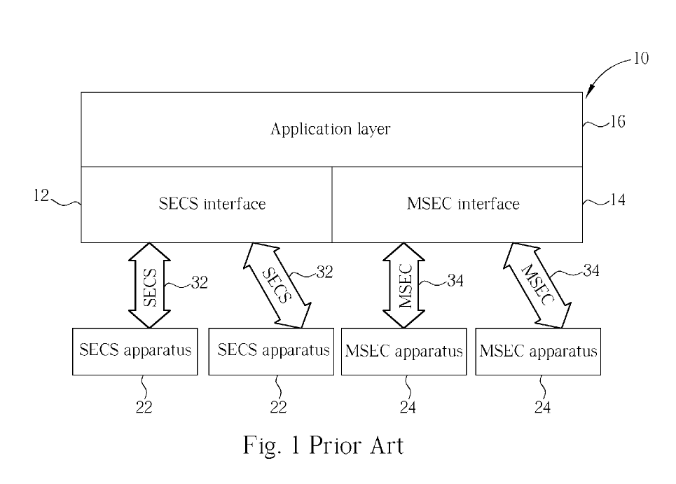

FIG. 2 is a diagram of an MSEC/SECS protocol converter, a computer host, and semiconductor apparatus according the present invention.

FIG. 3 is a block diagram of the MSEC/SECS protocol converter according to the present invention.

FIG. 4 is a flowchart for transforming MSEC signals into SECS signals according to the present invention.

FIG. 5 is a corresponding chart of the data structure when transforming MSEC signals into SECS signals according to the present invention.

FIG. 6 is a flowchart for transforming SECS signals into MSEC signals according to the present invention.

FIG. 7 is a corresponding chart of the data structure when transforming SECS signals into MSEC signals according to the present invention.

### DETAILED DESCRIPTION

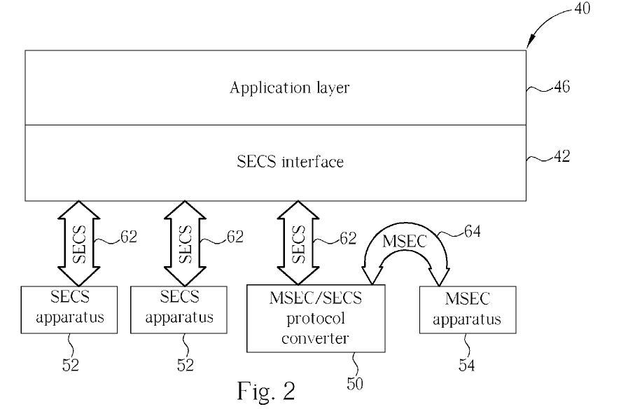

Please refer to FIG. 2. FIG. 2 is a diagram of an MSEC/SECS protocol converter 50, a computer host 40, and semiconductor apparatus according the present invention. The computer host 40 connects to a plurality of SECS apparatus 52 and at least one MSEC apparatus 54 through the MSEC/SECS protocol converter 50. The SECS apparatus 52 are the semiconductor apparatus that communicate using SECS protocol, and the MSEC apparatus 54 are the semiconductor apparatus that communicate using MSEC protocol. The MSEC/SECS protocol converter 50 converts signals between the MSEC and SECS protocols. The SECS apparatus 52 and the MSEC apparatus 54 are both used to perform the specified semiconductor processes. The computer host 40 transmits and receives SECS signals 62 to control operations of the SECS apparatus 52 and the MSEC apparatus 54, and comprises an SECS interface 42 and an application layer 46. The SECS interface 42, the MSEC/SECS protocol converter 50, and the SECS apparatus 52 transmit and receive SECS signals 62 using RS-232 ports. The application layer 46 processes the SECS signals transmitted and received by the SECS interface 42. The MSEC signals 64 outputted by the MSEC apparatus 54 are converted into the SECS signals 62 through the MSEC/SECS protocol converter 50, and are transmitted to the application 46 of the computer host 40 by the SECS interface 42. On the other hand, the SECS signals 62 outputted by the SECS interface 42 of the computer host 40 are converted into the MSEC signals 64 through the MSEC/SECS protocol converter 50, and are transmitted to the MSEC apparatus 54. Thus, the MSEC apparatus 54 does not need to have setting changes to connect it through the MSEC/SECS protocol converter 50 to the control system having the SECS protocol.

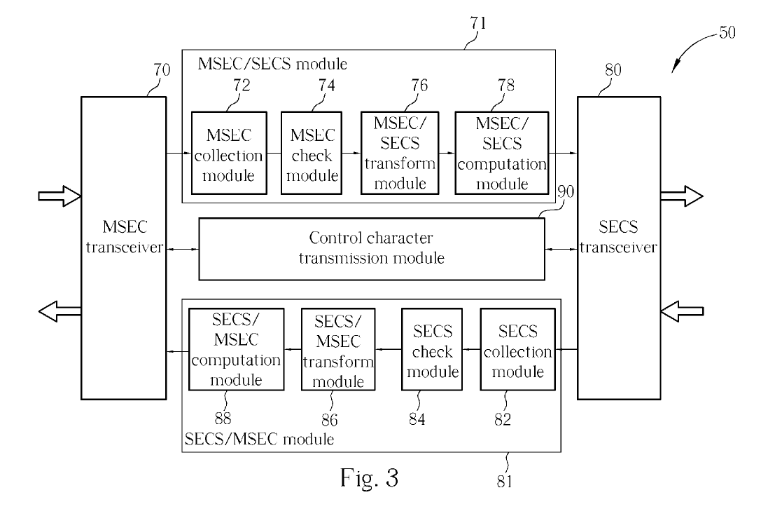

To describe the detailed conversion method of the MSEC/SECS protocol converter 50, please refer to FIG. 3. FIG. 3 is a block diagram of the MSEC/SECS protocol converter 50 according to the present invention. The MSEC/SECS protocol converter 50 comprises an MSEC transceiver 70, an MSEC/SECS module 71, an SECS transceiver 80, an SECS/MSEC module 81, and a control character transmission module 90. The MSEC transceiver 70 and the SECS transceiver 80 transmit and receive the MSEC signals 64 and the SECS signals 62 shown in FIG. 2, respectively. Please refer to FIG. 2 and FIG. 3. The MSEC/SECS module 71 transforms the MSEC signals 64 into the SECS signals 62, and the SECS/MSEC module 81 transforms the SECS signals 62 into the MSEC signals 64. The control character transmission module 90 is electronically connected to the MSEC transceiver 70 and the SECS transceiver 80 for transmitting the control characters defined in the protocols, including en-query (ENQ), end of transfer (EOT), acknowledge (ACK), and non-acknowledge (NAK).

The MSEC/SECS module 71 comprises an MSEC collection module 72, an MSEC check module 74, an MSEC/SECS transform module 76, and an MSEC/SECS computation module 78. The MSEC collection module 72 is electronically connected to the MSEC transceiver 70 for collecting the MSEC signals that are not the control characters and checking the integrity of the collected MSEC signals according to the length of the MSEC signals. The MSEC check module 74 is electronically connected to the MSEC collection module 72 for checking the even check bit and the checksum. The MSEC/SECS transform module 76 is electronically connected to the MSEC check module 74 for transforming the header and data of MSEC signals into header data in the SECS format. The MSEC/SECS computation module 78 is electronically connected to the MSEC/SECS transform module 76 and the SECS transceiver 80 for computing and updating the length and the checksum of SECS signals transformed by the MSEC/SECS transform module 76, and transmitting the SECS signals to the SECS transceiver 80.

The SECS/MSEC module 81 comprises an SECS collection module 82, an SECS check module 84, an SECS/MSEC transform module 86, and an SECS/MSEC computation module 88. The SECS collection module 82 is electronically connected to the SECS transceiver 80 for collecting the SECS signals that are not the control characters and checking integrity of the collected SECS signals according to the length of the SECS signals. The SECS check module 84 is electronically connected to the SECS collection module 82 for checking the even check bit and the checksum. The SECS/MSEC transform module 86 is electronically connected to the SECS check module 84 for transforming the header and data of SECS signals into those with MSEC format. The SECS/MSEC computation module 88 is electronically connected to the SECS/MSEC transform module 86 and the MSECS transceiver 70 for computing and updating the length and the checksum of MSEC signals transformed by the SECS/MSEC transform module 86, and transmitting the MSEC signals to the MSEC transceiver 70.

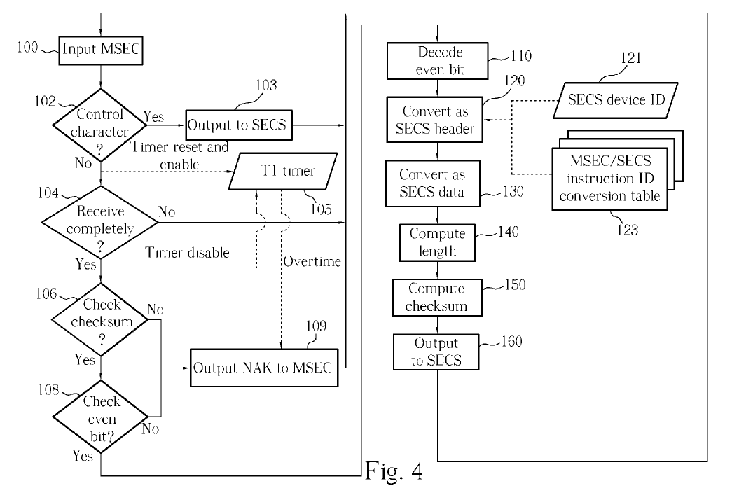

Please refer to FIG. 3 and FIG. 4. FIG. 4 is a flowchart for transforming MSEC signals into SECS signals according to the present invention. The signal conversion flow comprises the following steps:

Step 100: Inputting an MSEC signal using the MSEC transceiver 70.

Step 102: Judging if the inputted MSEC signal is a control character, including ENQ, EOT, ACK, and NAK, and performing step 103 if the MSEC signal is a control character or performing step 104 if the MSEC signal is not a control character.

Step 103: Transmitting the control character to the SECS transceiver 80 through the control character transmission module 90, which is separate from the MSEC/SECS module 71 and the SECS/MSEC module 81, transmitting the control character to the computer host by the SECS transceiver 80, and performing step 100 to receive the next MSEC signal.

Step 104: Enabling and resetting a T1 timer 105 to judge if the MSEC collection module 72 has collected the MSEC signals in a specified period, and performing step 109 if it is overtime or performing step 106 if the MSEC signal is received completely.

Step 106: Disabling the T1 timer 105, checking if the checksum of the MSEC signal is correct by using the MSEC check module 74, and performing step 109 if the checksum is incorrect or performing step 108 if the checksum being correct.

Step 108: Checking if the even check bit is correct by using the MSEC check module 74, and performing step 109 if the even check bit is incorrect or performing step 110 if the even check bit is correct.

Step 109: Outputting a control signal NAK to the MSEC apparatus through the MSEC transceiver 70 to make the MSEC apparatus re-output the MSEC signal to the MSEC/SECS protocol converter, and performing step 100.

Step 110: Decoding the even check bit of the MSEC signal by using the MSEC/SECS transform module 76. This involves removing the even check bit of the MSEC signal, and storing the even-check-bit decoded data in a corresponding portion of the SECS signal.

Step 120: Transforming the header of MSEC signal into that with SECS format by using the MSEC/SECS module 76 with an SECS apparatus identification (ID) 121 and an MSEC/SECS instruction ID conversion table 123.

Step 130: Transforming the data portion of the MSEC signal into the SECS format by using the MSEC/SECS transform module 76.

Step 140: Computing the length of the SECS signal transformed in step 120 and step 130 by using the MSEC/SECS computation module 78 to update the length of the SECS signal.

Step 150: Computing the checksum of the SECS signal transformed in step 120 and step 130 by using the MSEC/SECS computation module 78 to update the checksum of the SECS signal.

Step 160: Outputting the transformed SECS signal to the SECS transceiver 80 to transmit the transformed SECS signal to the computer host, and performing step 100 to receive the next MSEC signal.

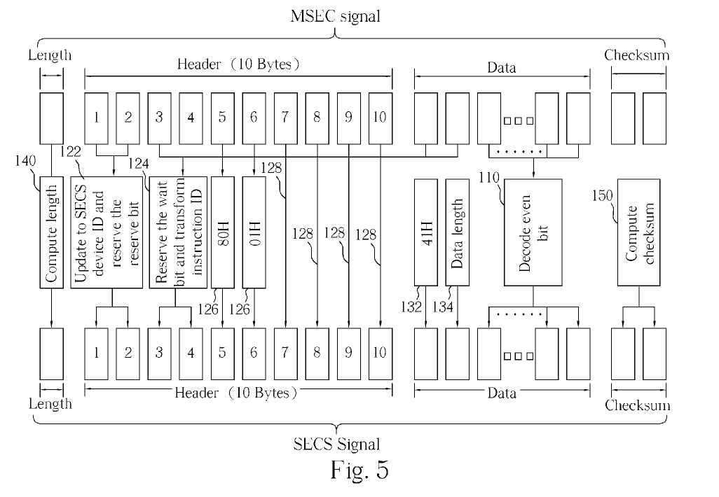

Please refer to FIG. 5. FIG. 5 is a corresponding chart of the data structures when transforming MSEC signals into SECS signals as shown in FIG. 4 according to the present invention. The step 120 of transforming the header shown in FIG. 4 includes a transform step 122, a transform step 124, a transform step 126, and a transform step 128. The transform step 122 updates the first and second bytes of the header of the MSEC signal to an SECS apparatus ID defined by a user and reserves the reserve bit. The transform step 124 generates an SECS instruction ID to store in the third and fourth bytes of the header of the SECS signal according to the third byte and the data portion of the header of the MSEC signal and reserves the wait bit of the MSEC signal. The transform step 126 sets the fifth and sixth bytes of the header of the SECS signal to ASCII 80H and 01H, respectively. The transform step 128 sets the seventh to tenth bytes of the header of the MSEC signal to the seventh to tenth bytes of the header of the SECS signal. The transforming data step 130 includes a transforming step 132 and a transforming step 134. The transforming step 132 sets the first byte of the data portion of the SECS signal to ASCII 41H, and the transform step 134 sets the second byte of the data portion of the SECS signal to the data length.

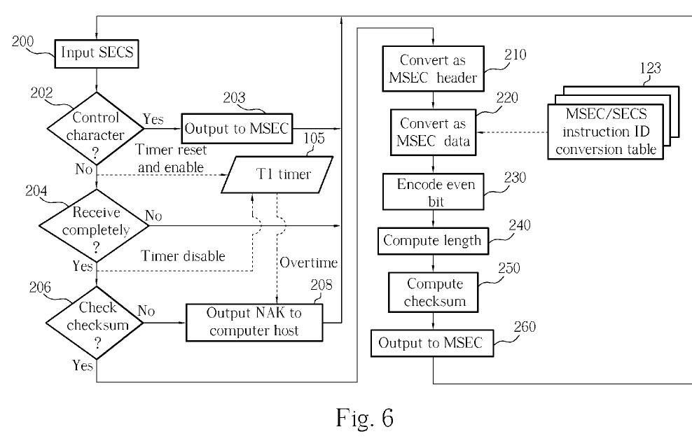

Please refer to FIG. 3 and FIG. 6. FIG. 6 is a flowchart for transforming SECS signals into MSEC signals according to the present invention. The signal conversion flow comprises the following steps:

Step 200: Inputting an SECS signal by using the SECS transceiver 80.

Step 202: Judging if the inputted SECS signal is a control character, and performing step 203 if the SECS signal is a control character or performing step 204 if the SECS signal is not a control character.

Step 203: Transmitting the control character to the MSEC transceiver 70 through the control character transmission module 90, which is separate from the MSEC/SECS module 71 and the SECS/MSEC module 81, transmitting the control character to the computer host using the MSEC transceiver 70, and performing step 200 to receive the next SECS signal.

Step 204: Enabling and resetting a T1 timer 105 to judge if the SECS collection module 82 has collected the SECS signals in a specified period, and performing step 208 if it is overtime or performing step 206 if the SECS signal is received completely.

Step 206: Disabling the T1 timer 105, checking if the checksum of the SECS signal is correct by using the SECS check module 84, and performing step 208 if the checksum is incorrect or performing step 220 if the checksum is correct.

Step 208: Outputting a control signal NAK to the computer host through the SECS transceiver 80 to make the computer host re-output the SECS signal to the MSEC/SECS protocol converter, and performing step 200.

Step 210: Transforming the header of the SECS signal into the MSEC format by using the SECS/MSEC transform module 86.

Step 220: Transforming the data portion of the SECS signal into the MSEC format by using the SECS/MSEC module 86 with the SECS/MSEC instruction ID conversion table 123.

Step 230: Encoding the data portion transformed in the step 220 by using the SECS/MSEC transform module 86 and the method of adding the even check bit to the transformed signal.

Step 240: Computing the length of the MSEC signal transformed in steps 210, 220, and 230 by using the SECS/MSEC computation module 88 to update the length of the MSEC signal.

Step 250: Computing the checksum of the MSEC signal transformed in steps 210, 220, and 230 by using the SECS/MSEC computation module 88 to update the checksum of the MSEC signal.

Step 260: Outputting the transformed MSEC signal to the MSEC transceiver 70 to transmit the transformed MSEC signal to the MSEC apparatus, and performing step 200 to receive the next SECS signal.

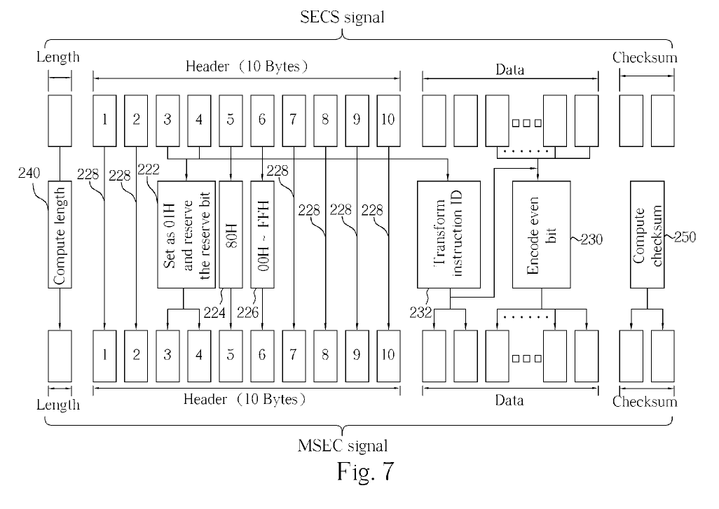

Please refer to FIG. 7. FIG. 7 is a corresponding chart of the data structures when transforming SECS signals into MSEC signals as shown in FIG. 6 according to the present invention. The step 210 of transforming the header shown in FIG. 6 includes a transform step 222, a transform step 224, a transform step 226, and a transform step 228. The transform step 222 updates the third and fourth bytes of the header of the SECS signal to ASCII 01H, and reserves the wait bit to store in the third and fourth bytes of the header of the MSEC signal. The transform step 224 sets the fifth byte of the header of the MSEC signal to 80H, and the transform step 226 sets the sixth byte of the header of the MSEC signal to one of ASCII 00H to FFH. The transform step 228 sets the seventh to tenth bytes of the header of the SECS signal to the seventh to tenth bytes of the header of the MSEC signal. The transforming data step 230 includes a transforming step 232. The transforming step 232 transforms the instruction ID of the third and fourth bytes of the header of the SECS signal to store in the first and second bytes of the data portion of the MSEC signal. The step 230 encodes the instruction ID transformed in the step 232 and the even check bit of the data portion of the MSEC signal and stores the encoded data portion in the bytes being behind the third bytes of data portion of the MSEC signal.

In the above-mentioned flowcharts of FIG. 4 and FIG. 6, the MSEC/SECS conversion method includes inputting an MSEC signal or an SECS signal, judging if the MSEC signal or the SECS signal is a control character (directly outputting the control character if the MSEC signal or the SECS signal are the control character), receiving the MSEC signal or the SECS signal, checking the checksum of the collected MSEC signal or the SECS signal, transforming the MSEC signal or the SECS signal into a transformed SECS or MSEC signal, respectively, computing and updating the length and the checksum of the transformed MSEC or SECS signal, and outputting the transformed MSEC or SECS signal. What is different is the even check bit exists in the MSEC signal, which is needed to check the even check bit and decode in the transforming the MSEC signal into the SECS signal step. The even check bit does not exist in the SECS data, which is needed to encode in the step of transforming the SECS signal into the MSEC signal. In addition, the timer used to receive the MSEC signal and the SECS signal can be omitted or replaced by other programs such as loop programs.

The present invention converter also uses the one-direction MSEC/SECS signal conversion method. That is, a converter is made to transform an MSEC signal into an SECS signal according to the conversion method of transforming the MSEC signal to the SECS signal, or a converter is made to transform an SECS signal to an MSEC signal according to the conversion method of transforming the SECS signal to the MSEC signal.

In contrast to the prior art, a computer host using different protocols interfaces to transmit and receive signals having different protocols, but the present invention MSEC/SECS protocol converter and conversion method exchange the protocols of MSEC signals and SECS signals. Thus, the computer host only needs the SECS interface to transmit and receive signals, which reduces the complexity and processing requirements of the computer host. In addition, applying the present invention protocol converter or conversion method does not involve modifying the current apparatus that are connected to the computer host, which reduces much of the modification cost.

Those skilled in the art will readily observe that numerous modifications and alterations of the apparatus may be made while retaining the teachings of the invention. Accordingly, that above disclosure should be construed as limited only by the metes and bounds of the appended claims.

1. An MSEC/SECS protocol converter, comprising:
a first transceiver for transmitting and receiving Mitsubishi SEMI Equipment Communication (MSEC) signals;
a second transceiver for transmitting and receiving SEMI Equipment Communication Standard (SECS) signals;
an MSEC/SECS module for transforming MSEC signals into SECS signals;
an SCES/MSEC module for transforming SECS signals into MSEC signals; and
a control character transmission module, wherein when one of the first and second transceivers receives a control character, the control character transmission module directly transmits the received control character to the other transceiver.

2. The MSEC/SECS protocol converter of claim 1, wherein the MSEC/SECS module comprises:
a first collection module electronically connected to the first transceiver for collecting MSEC signals and checking the integrity of the collected MSEC signals;
a first check module electronically connected to the first collection module for checking correction of the MSEC signals collected by the first collection module;
a first transform module electronically connected to the first check module for transforming the MSEC signals checked by the first check module into SECS signals; and
a first computation module electronically connected to the first transform module and the second transceiver for computing and updating the SECS signals transformed by the first transform module; and
the SECS/MSEC module comprising:
a second collection module electronically connected to the second transceiver for collecting SECS signals and checking the integrity of the collected SECS signals;
a second check module electronically connected to the second collection module for checking correction of the SECS signals collected by the second collection module;
a second transform module electronically connected to the second check module for transforming the SECS signals checked by the second check module into MSEC signals; and
a second computation module electronically connected to the second transform module and the first transceiver for computing and updating the MSEC signals transformed by the second transform module.

3. The MSEC/SECS protocol converter of claim 2, wherein the first collection module collects MSEC signals according to a timer, and the second collection module collects SECS signals according to the timer.

4. The MSEC/SECS protocol converter of claim 2, wherein the first check module checks the even check bit and the checksum of the MSEC signals collected by the first collection module, and the first computation module computes and updates the length and the checksum of the SECS signals transformed by the first transform module.

5. The MSEC/SECS protocol converter of claim 2, wherein the second check module checks the checksum of the SECS signals collected by the second collection module, and the second computation module computes and updates the length and the checksum of the MSEC signals transformed by the second transform module.

6. The MSEC/SECS protocol converter of claim 1, wherein the control character is selected from a group consisting of en-query (ENQ), end of transfer (EOT), acknowledge (ACK), and non-acknowledge (NAK).

7. The MSEC/SECS protocol converter of claim 1, wherein the first and second transceivers transmit and receive MSEC signals and SECS signals by using RS-232 ports.

8. A conversion method of semiconductor apparatus protocols, the method comprising:
transmitting and receiving MSEC signals from a first transceiver;
transmitting and receiving SECS signals from a second transceiver;
transforming the MSEC signals received by the first transceiver into SECS signals by using an MSEC/SECS module and outputting the transformed SECS signals by using the second transceiver;
transforming the SECS signals received by the second transceiver into MSEC signals by using an SECS/MSEC module and outputting the transformed MSEC signals by using the first transceiver; and
transmitting a control character to one of the first and second transceivers directly by using a control character transmission module when the other transceiver receives the control character.

9. The conversion method of claim 8, wherein the MSEC/SECS module comprises a first collection module, a first check module, a first transform module, and a first computation module, and the SECS/MSEC module comprises a second collection module, a second check module, a second transform module, and a second computation module, the conversion method further comprising: utilizing the first collection module to collect MSEC signals and check the integrity of the collected MSEC signals;
utilizing the first check module to check correction of the MSEC signals collected by the first collection module;
utilizing the first transform module to transform the MSEC signals checked by the first check module into SECS signals;
utilizing the first computation module to compute and update the SECS signals transformed by the first transform module;
utilizing the second collection module to collect SECS signals and check the integrity of the collected SECS signals;
utilizing the second check module to check correction of the SECS signals collected by the second collection module;
utilizing the second transform module to transform the SECS signals checked by the second check module into MSEC signals; and
utilizing the second computation module to compute and update the MSEC signals transformed by the second transform module.

10. The conversion method of claim 8, wherein the first collection module collects MSEC signals according to a timer, and the second collection module collects SECS signals according to the timer.

11. The conversion method of claim 8, wherein the first check module checks the even check bit and the checksum of the MSEC signals collected by the first collection module, and the first computation module computes and updates the length and the checksum of the SECS signals transformed by the first transform module.

12. The conversion method of claim 8, wherein the second check module checks the checksum of the SECS signals collected by the second collection module, and the second computation module computes and updates the length and the checksum of the MSEC signals transformed by the second transform module.

13. The conversion method of claim 8, wherein the control character is selected from a group consisting of ENQ, EOT, ACK, and NAK.

14. The conversion method of claim 8, wherein the first and second transceivers transmit and receive MSEC signals and SECS signals using by RS-232 ports.

15. A conversion method of semiconductor apparatus protocols, the method at least comprising:
inputting a first signal, wherein the first signal has one format of an MSEC signal and an SECS signal;
judging if the first signal is a control character, and outputting the first signal if the first signal is the control character;
receiving the first signal;
checking the checksum of the received first signal;
transforming the first signal into another format of the MSEC signal and the SECS signal;
computing and updating the length and the checksum of the transformed first signal; and
outputting the transformed first signal.

16. The conversion method of claim 15, further comprising resetting and enabling a timer when receiving the first signal.

17. The conversion method of claim 15, wherein if the first signal is transformed from the MSEC signal into the SECS signal, before the step of transforming the first signal into the SECS signal, the conversion method further comprises:
checking the even check bit of the collected first signal; and
decoding the even check bit of the first signal.

18. The conversion method of claim 15, wherein if the first signal is transformed from the SECS signal into the MSEC signal, after the step of transforming the first signal into the MSEC signal, the conversion method further comprises encoding the even check bit.

19. The method of claim 15, wherein the step of transforming the first signal from the MSEC signal into the SECS signal comprises:
transforming the first and second bytes of the header of the first signal into SECS apparatus identification (ID) and reserving the reserve bit of the first signal;
generating an SECS instruction ID according to the third byte of the header of the first signal and the first and second bytes of the data portion, storing the SECS instruction ID in the third and fourth bytes of the header of the first signal, and reserving the wait bit of the first signal;
setting the fifth and sixth bytes of the header of the first signal as ASCII 80H and 01H; and
setting the seventh to tenth bytes of the header of the first signal as the seventh to tenth bytes of the header of the transformed first signal.

20. The method of claim 19, wherein the step of transforming the first signal utilizes an SECS apparatus ID.

21. The method of claim 15, wherein the step of transforming the first signal from the SECS signal into the MSEC signal comprises:
transforming the third and fourth bytes of the header of the first signal into ASCII 01H, reserving a wait bit of the first signal, and storing the wait bit in the third and fourth bytes of the header of the first signal;
setting the fifth byte of the header of the first signal as 80H;
setting the sixth byte of the header of the first signal as one of OOH to FFH;
setting the first, second, and seventh to tenth bytes of the header of the first signal as the first, second, and seventh to tenth bytes of the header of the transformed first signal; and
transforming the instruction ID of the third and fourth bytes of the header of the first signal, and storing in the first and second bytes of the data portion of the transform first signal.

22. The conversion method of claim 15, wherein the control character is selected from a group consisting of ENQ, EOT, ACK, and NAK.

23. The conversion method of claim 15, wherein the step of resetting and enabling the timer and receiving the first signal further comprises judging if the first signal is received within a specified period, and outputting a NAK control signal if the first signal is overtime.

24. The conversion method of claim 15, further comprising outputting a NAK control signal if one of the checksum and the even check bit of the first signal is incorrect.

25. The conversion method of claim 15, wherein the first signal is transmitted and received according to the protocol of RS-232 ports.

26. The conversion method of claim 15, wherein the step of transforming the first signal utilizes an MSEC/SECS instruction ID conversion table.

27. A converter for transforming MSEC signals and SECS signals according to the conversion method of semiconductor apparatus protocols of claim 15.
